(19) United States
(12) Patent Application Publication
(10) Pub. No.: US 2006/0152465 A1
(43) Pub. Date: Jul. 13, 2006

(54) REFERENCE VOLTAGE SELECTION DEVICE AND SOURCE DRIVER DEVICE AND DISPLAY DEVICE USING THE SAME

(76) Inventor: Chien-Hsien Kao, Taipei City (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(21) Appl. No.: 11/160,288

(22) Filed: Jun. 17, 2005

(30) Foreign Application Priority Data
Jan. 7, 2005 (TW) 94100436

(51) Int. Cl. G09G 3/36

(52) U.S. Cl. 345/100

(57) ABSTRACT

A reference voltage selection device suitable for a display device comprising a digital to analog converter is provided. The digital to analog converter may include a plurality of input terminals and may be adopted for providing a displaying voltage to the display device. The selection device may include a reference voltage selector for receiving a plurality of basic reference voltages, wherein the reference voltage selector is suitable for selecting a relationship between the basic reference voltages and the input terminals to reduce an error between the displaying voltage and a predetermined standard voltage.

### CROSS-REFERENCE TO RELATED APPLICATION

This application claims the priority benefit of Taiwan application serial no. 941 00436, filed on Jan. 7, 2005. All disclosure of the Taiwan application is incorporated herein by reference.

### BACKGROUND OF THE INVENTION

1. Field of the Invention

The present invention relates to a display device. More particularly, the present invention relates to a source driver device of a display device.

2. Description of Related Art

Recently, liquid crystal display (LCD) panel has gradually become the mainstream of display panel because of their advantageous features of light weight, compact size, suitable for large or small area application, low operation voltage, low power consumption, and radiation free. Especially, LCD panel is more applicable for portable electronic device such as the display of notebook, mobile phone, or personal digital assistance (PDA). Therefore, the LCD panel has become an indispensable device and its development is very important.

FIG. 1 is a schematic view of a conventional liquid crystal display. As shown in FIG. 1, a conventional LCD 100 generally includes a liquid crystal panel 102, a gate driver 104 and a source driver 106. The liquid crystal panel 102 includes a pixel array constructed by a plurality of pixels. For example, a conventional liquid crystal panel with 1024×768 resolution has 1024 columns and 768 rows of pixels, wherein each pixel has three sub-pixels having red, green and blue colors respectively. Therefore, the foregoing liquid crystal panel has 3072 columns and 768 rows of sub-pixels. As shown in FIG. 1, the pixel 112 in the first column of the liquid crystal panel 102 has three sub-pixels, i.e., a red sub-pixel 112r, a green sub-pixel 112g, and a blue sub-pixel 112b. In addition, the first column also includes another pixels such as pixel 114 and so on. Each sub-pixel has a thin film transistor (TFT) and a capacitor, wherein the capacitor is connected between the drain of the TFT and the common electrode. The gate of the TFT is controlled by the gate driver 104 via a corresponding scan line. For example, the gates of the thin film transistors of the sub-pixels 112r, 112g and 112b is controlled by the scan line SL1. The source of the TFT is controlled by the source driver 106 via a corresponding data line. For example, the sources of the thin film transistors of the sub-pixels 112r and 122r are controlled by the data line DL1.

The gate driver 104 receives a basic clock and a start pulse. After the start pulse is received by the gate driver 104, a plurality of scan signals are generated according to the basic clock and output to the scan lines SL1, SL2 to SLm sequentially.

The source driver 106 receives a digital input data input in serial, and then the digital input data is converted into an analog data and output to data lines DL1, DL2 to DLn in parallel simultaneously. Therefore, in a period of time, when the gate driver 104 receives the start pulse and output a scan signal to a specific scan line (e.g., scan line SL1 ) to turn on the gates of the thin film transistors of the pixels (e.g., the sub-pixels 112r, 112g, 112b and etc.), the analog data is input to the sources of the thin film transistors of the sub-pixels 112r, 112g, 112b via the data lines DL1, DL2 to DLn in the period of time, and then the analog data is stored in the capacitor via the drain of the TFT.

In a conventional source driver 106, after the digital input data is received, the digital input data is converted into the analog data via a digital to analog converter, wherein an applicable voltage is selected from a set of reference voltage and provided as the analog data principle according to the level of the digital input data. For example, if the brightness of the digital input signal of the sub-pixel of the liquid crystal panel 102 as shown in FIG. 1 has 6 bits gray scale level, the set of reference voltage has 26=64 reference voltages. Thus, the brightness of the sub-pixel is dependent on the reference voltage stored in its capacitor. In general, the relationship between the brightness BR, BG and BB of the three primary colors (red, green and blue) of the sub-pixels (e.g., sub-pixels 112r, 112g, 112b respectively) and the corresponding gray scale levels GR, GG and GB may be represent by the following equations (1) to (3):
BR=GR^{γ} (1)
BG=GG^{γ} (2)
BB=GB^{γ} (3)

Wherein, γ represent gamma value parameter, conventionally, γ=2.2.

FIG. 2 is a plot of brightness versus gray scale of a sub-pixel of a conventional LCD panel. Referring to FIG. 2, curve C1 represents a standard curve of the relationship between the brightness and the gray scale of the sub-pixel, and curve C2 represents the actual relationship between the brightness and the gray scale obtained by the set of the reference voltages. It is noted that, the difference between the actual curve C2 and the standard curve C1 may be called an error of the curve C1. Generally, the error may be generated by the error of the device providing the set of the reference voltage. Moreover, the curve C2 is dependent on the structure of the liquid crystal panel and the property of liquid crystal. Therefore, the error of the curve C1 may also be changed.

Conventionally, the number of the reference voltages of the set of reference voltage may be increased to reduce the error. However, the layout may be more complex and of large size, e.g., additional components such as operational amplifiers (generally, the output terminal of each reference voltage needs an operational amplifier) are required. Therefore, the cost may be increased. In addition, the circuit for generating the set of the reference voltages is generally disposed in the chip of the source driver 106. Therefore, if the design of the source driver 106 should be changed corresponding to the structure of the liquid crystal panel and the property of liquid crystal, the cost of manufacturing the chip is too high. Accordingly, it is important to develop a circuit for generating applicable reference voltages for a variety of different liquid crystal panel structures.

### SUMMARY OF THE INVENTION

Accordingly, the present invention relates to a reference voltage selection device suitable for a display device comprising a digital to analog converter. The reference voltage selection device may be adopted for adjusting the connection between the basic reference voltages and the digital to analog converter to reduce or minimize an error between the actual brightness and the standard brightness of the display device.

In addition, the present invention relates to a source driver device of a display device suitable for any kind of liquid crystal panel structure or any property of liquid crystal. The source driver device may be adopted for adjusting the connection between the basic reference voltages and the digital to analog converter to reduce or minimize an error between the actual brightness and the standard brightness of the display device.

Moreover, the present invention relates to a display device suitable for any kind of liquid crystal panel structure or any property of liquid crystal. The display device may be adopted for adjusting the connection between the basic reference voltages and the digital to analog converter to reduce or minimize an error between the actual brightness and the standard brightness of the display device.

According to one embodiment of the present invention, a reference voltage selection device suitable for a display device comprising a digital to analog converter is provided. The digital to analog converter may comprise, for example, a plurality of input terminals and may be adopted for providing a predetermined displaying voltage to the display device. The selection device may comprise a reference voltage selector for receiving a plurality of basic reference voltages, wherein the reference voltage selector is suitable for selecting a relationship between the basic reference voltages and the input terminals to reduce an error between the displaying voltage and a predetermined standard voltage.

In one embodiment of the present invention, the reference voltage selection device further comprises a control connected to the reference voltage selector, wherein the control device may be adopted for receiving a control signal to adjust the relationship between the basic reference voltages and the input terminals

In one embodiment of the present invention, the reference voltage selector may be adopted for selecting the relationship between the basic reference voltages and the input terminals according to a predetermined method. In addition, the predetermined method may comprise a method designed on a panel with known V-T properties and several panels without known V-T properties for setting up a relationship, based on a predetermined relating algorithm. Moreover, the predetermined method may comprise a method designed on multiple panels with known V-T properties by using a calculation manner to calculate a specific relationship between the basic reference voltages and the input terminals so as to minimize the error between the displaying voltage and a predetermined standard voltage.

In one embodiment of the present invention, the digital to analog converter may comprise a voltage dividing device comprising a plurality of nodes, wherein each of the nodes is connected to one of the input terminals, and a voltage divider is connected between every two nodes. In another embodiment of the present invention, each voltage divider may comprise a resistor or a capacitor.

In one embodiment of the present invention, the reference voltage selector further comprises an electro-static current protection device disposed at a terminal for receiving one of the basic reference voltages.

In one embodiment of the present invention, the basic reference voltage may be adjusted to reduce the error between the displaying voltage and the predetermined standard voltage of the display device.

According to another embodiment of the present invention, a source driver device for a display device is provided. The source driver device may comprise a receiving device, a digital to analog converter, an output buffer and a reference voltage selection device. The receiving device may be adopted for receiving and registering an input data and outputting a plurality of digital data in parallel. The digital to analog converter may be connected to the receiving device and adaptable for receiving and converting the digital data into a plurality of displaying voltages, wherein the digital to analog converter comprises a plurality of input terminals. The output buffer may be connected to the digital to analog converter for outputting each of the displaying voltages to a data line. The reference voltage selector may be adaptable for receiving a plurality of basic reference voltages, wherein the reference voltage selector is suitable for selecting a relationship between the basic reference voltages and the input terminals to reduce an error between the displaying voltage and a predetermined standard voltage.

In one embodiment of the present invention, the receiving device may comprise a first latch and a second latch. The first latch may be adopted for receiving an input data. The second latch may be connected to the first latch for registering the input data received by the first latch and output the digital data in parallel. In another embodiment of the present invention, the receiving device may further comprise a shift register connected to the second latch for inputting the input data received by the first latch to the second latch under a control of a timing signal.

In one embodiment of the present invention, the second latch may comprise a line latch.

According to another embodiment of the present invention, a display device comprising, for example, a panel, a gate driver and a source driver is provided. The panel may comprise a plurality of pixels, wherein each pixel may comprise, for example, a transistor. The gate driver may comprise a plurality of scan lines, wherein each scan line may be connected to a gate of one of the transistors of the pixels of the liquid crystal panel. The source driver may comprise a plurality of data lines, wherein each data line may be connected to a source of one of the transistors of the pixels of the liquid crystal panel. The source driver source driver device may comprise a receiving device, a digital to analog converter, an output buffer and a reference voltage selection device. The receiving device may be adopted for receiving and registering an input data and outputting a plurality of digital data in parallel. The digital to analog converter may be connected to the receiving device and adaptable for receiving and converting the digital data into a plurality of displaying voltages, wherein the digital to analog converter comprises a plurality of input terminals. The output buffer may be connected to the digital to analog converter for outputting each of the displaying voltages to a data line. The reference voltage selector may be adaptable for receiving a plurality of basic reference voltages, wherein the reference voltage selector is suitable for selecting a relationship between the basic reference voltages and the input terminals to reduce an error between the displaying voltage and a predetermined standard voltage.

In one embodiment of the present invention, the panel may comprise a liquid crystal panel.

One or part or all of these and other features and advantages of the present invention will become readily apparent to those skilled in this art from the following description wherein there is shown and described one embodiment of this invention, simply by way of illustration of one of the modes best suited to carry out the invention. As it will be realized, the invention is capable of different embodiments, and its several details are capable of modifications in various, obvious aspects all without departing from the invention. Accordingly, the drawings and descriptions will be regarded as illustrative in nature and not as restrictive.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic circuit diagram of a conventional liquid crystal display.

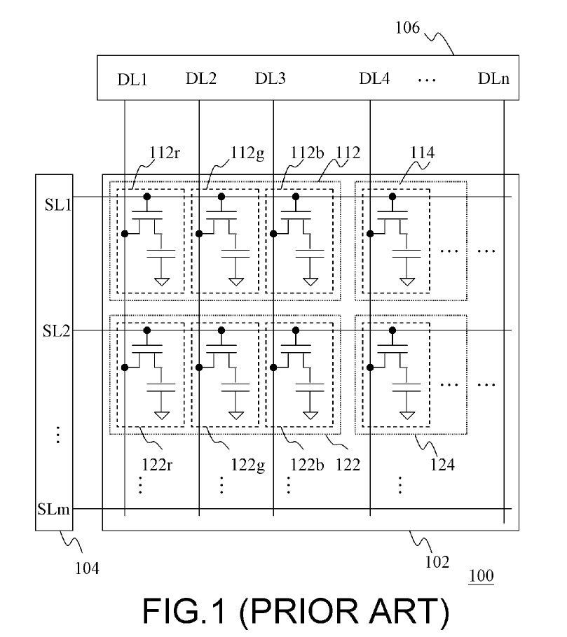

FIG. 2 is a plot of brightness versus gray scale of a sub-pixel of a conventional LCD panel.

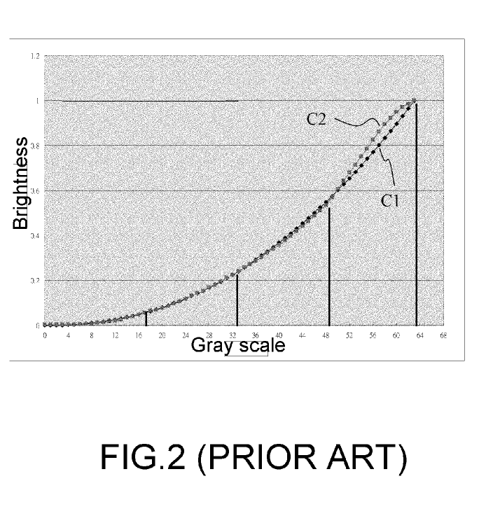

FIG. 3 is a schematic circuit block diagram of a source driver of a LCD panel according to one embodiment of the present invention.

FIG. 4 is a schematic circuit block diagram of a digital to analog converter and a reference voltage selection device according to one embodiment of the present invention.

FIG. 5 is a plot of brightness versus gray scale of a sub-pixel of a LCD panel according to one embodiment of the present invention.

FIG. 6 is a schematic circuit block diagram of a digital to analog converter and a reference voltage selection device according to another embodiment of the present invention.

### DESCRIPTION OF EMBODIMENTS

The present invention now will be described more fully hereinafter with reference to the accompanying drawings, in which embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art. Like numbers refer to like elements throughout.

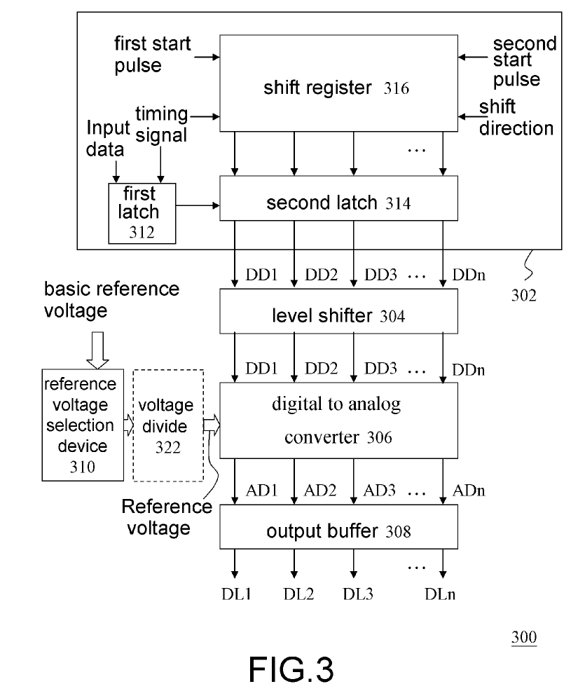

FIG. 3 is a schematic circuit block diagram of a source driver of a LCD panel according to one embodiment of the present invention. As shown in FIG. 3, a source driver 300 may comprise, for example, a receiving device 302, a level shifter 304, a digital to analog converter 306, an output buffer 308 and a reference voltage selection device 310. The receiving device 302 may be adopted for receiving and registering an input data (e.g., an input data input in serial), and outputting a plurality of digital data in parallel. In one embodiment of the present invention, receiving device 302 may comprise a first latch 312 and a second latch 314. The first latch 312 may be adopted for receiving the input data. The second latch 314 may be connected to the first latch 312 and adopted for register the input data received by the first latch 312 and output digital data DD1, DD2 to DDn in parallel. The first latch 312 may comprise, for example, a pre-latch. The second latch 314 may comprise, for example, a line latch. In another embodiment of the present invention, the receiving device 302 may further comprise a shift register 316 connected to the second latch 314. The shift register 316 may be adopted for inputting the input data received by the first latch 312 to the second latch 314 under the control of a timing signal.

The shift register 316 may comprise a single-directional shift register or a bi-directional shift register. The shift register 316 illustrated in FIG. 3 is a bi-directional shift register and may be adopted for receiving the timing signal, a shift direction signal, a first start pulse and a second start pulse. The shift register 316 may output the digital data in a direction from data lines DL1 to DLn corresponding to the first start pulse, or in another direction from data lines DLn to DL1 corresponding to the second start pulse according to the shift direction signal.

The second latch 314 may be connected to the shift register 316 and the level shifter 304. After the shift register 316 registers the input data of data lines DL1, DL2 to DLn to the second latch 314, the second latch 314 output the digital data DD1, DD2 to DDn to the level shifter 304 in parallel.

The level shifter 306 may be adopted for shifting the voltage level of the digital data DD1, DD2 to DDn. In one embodiment of the present invention, the level shifter 304 is optional. The determine whether to dispose the level shifter 304 or not is dependent on the requirement of the voltage level of the digital data DD1, DD2 to DDn.

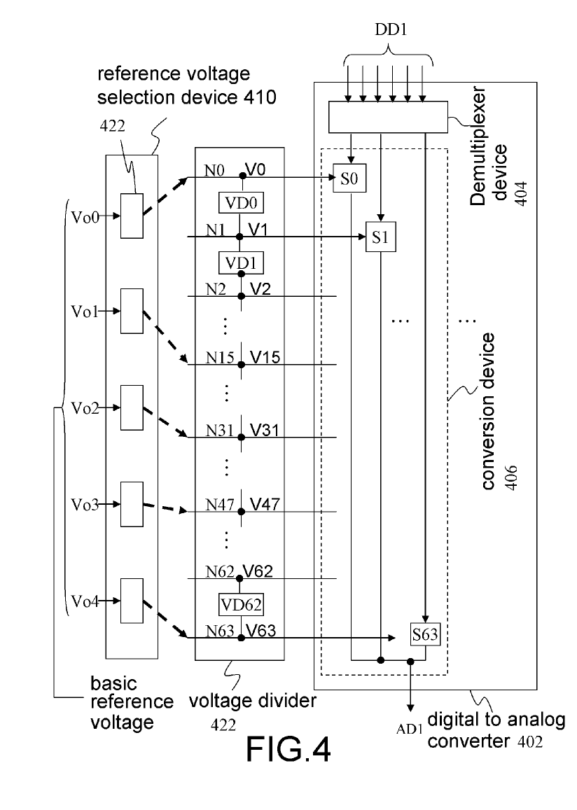

FIG. 4 is a schematic circuit block diagram of a digital to analog converter and a reference voltage selection device according to one embodiment of the present invention. Referring to FIG. 4, in one embodiment of the present invention, the digital to analog converter 402 may comprise, for example, a demultiplexer device 404, a conversion device 406 and a plurality of input terminals. The conversion device 406 may comprise, for example, a plurality of switches S0, S1 to S63, wherein each switch is connected to a corresponding input terminal. The demultiplexer device 404 receives the digital data DD1, DD2 to DDn input from the level shifter 304. In one embodiment of the present invention, for example, the demultiplexer device 404 shown in FIG. 4 comprises 6 input lines for receiving a digital data (e.g., digital data DD1) having 6 bits gray scale, and the 64 output lines of the demultiplexer device 404 output the signal of the converted 6 bits gray scale. Therefore, the demultiplexer device 404 may be adopted for converting the binary of 6 bits gray scale (e.g., 001011) of the digital data into a decimal of the gray scale (e.g., the decimal of 001011 is 11). Thereafter, in the 64 output lines of the demultiplexer device 404, only the switch S10 connected to the 11th output line may be turned on, and the other switches except for the switch S10 may not be turned on. Accordingly, the analog data AD1 output to the output buffer 308 may have, for example, a voltage V10 output from the node N10 of the voltage dividing device 422. In another embodiment of the present invention, the digital data is not only limited to 6 bits but may be decided by requirement. In another embodiment of the present invention, the voltage dividing device 422 may be comprised in the digital to analog converter 402.

In one embodiment of the present invention, the reference voltage selection device 410 may receive, for example, the basic reference voltages Vo0, Vo1 to Vo4, and then input the basic reference voltages Vo0, Vo1 to Vo4 to the corresponding nodes of the voltage dividing device 422. In one embodiment of the present invention, the voltage dividing device 422 may comprise, for example, nodes N0, N1, to N63. In addition, the voltage dividers VD0 to VD62 may be connected between every two nodes sequentially. As shown in FIG. 4, in one embodiment of the present invention, the basic reference voltages Vo0, Vo1, Vo2, Vo3, Vo4 may be input to nodes N0, N15, N31, N47, N63 respectively. In addition, the voltage of the other nodes except for the nodes N0, N15, N31, N47, N63 may be generated by the voltage dividers VD0 to VD62 of the voltage dividing device 422. The connection between the basic reference voltages Vo0, Vo1 to Vo4 and the nodes N0, N1, to N63 shown in FIG. 4 only represents one embodiment of the present invention and can not be used to limit the scope of the present invention. In another embodiment of the present invention, the reference voltage selection device 410 may be adopted for deciding a better or a best connection between the basic reference voltages Vo0, Vo1 to Vo4 and the nodes N0, N1, to N63 of the voltage dividing device 422 to adjust the reference voltage V0, V1 to V63 to reduce or minimize the error between the actual curve and the standard curve of the brightness.

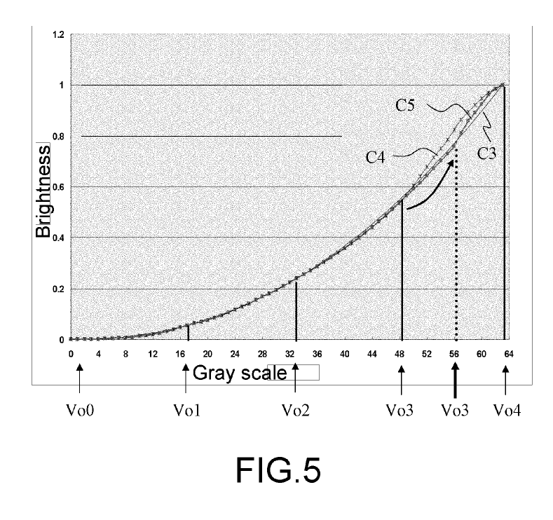

FIG. 5 is a plot of brightness versus gray scale of a sub-pixel of a LCD panel according to one embodiment of the present invention. Referring to FIG. 5, curve C3 represents a standard curve of brightness versus gray scale of the sub-pixel, for example but not limited to, the standard curve obtained by set γ=2.2 in the equations (1) to (3). In addition, the curve C4 represents a curve of brightness versus gray scale when the basic reference voltages Vo0, Vo1 to Vo4 are input to the nodes N0, N16, N32, N48 and N63 of the voltage dividing device 422 correspondingly. It is noted that, in the range of gray scale from 48 to 63, the error of the brightness between the curve C4 and the standard curve C3 is larger. Therefore, for example, in another embodiment of the present invention such as the curve C5, the basic reference voltages Vo0, Vo1, Vo2 and Vo4 are input to the nodes N0, N16, N32 and N63, but the reference voltage Vo3 is input to the node N56. It should be noted that the error of the brightness between the curve C5 and the standard curve is much less than that between the curve C4 and the standard curve C3.

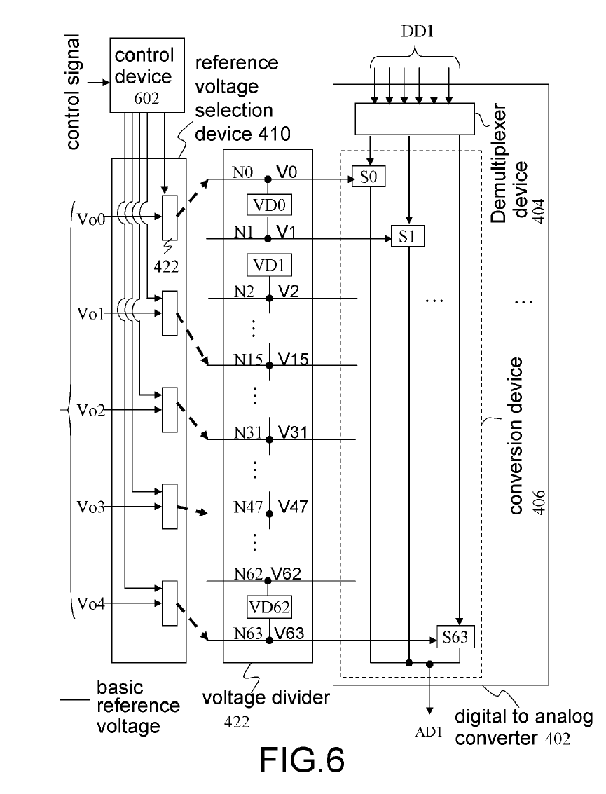

FIG. 6 is a schematic circuit block diagram of a digital to analog converter and a reference voltage selection device according to another embodiment of the present invention. In another embodiment of the present invention, as shown in FIG. 6, a control device 602 may be further connected to the reference voltage selection device 410, and may be adopted for receiving a control signal to adjust the connection between the basic reference voltages Vo0, Vo1 to Vo4 and the input terminals of the digital to analog converter 402, or to adjust the connection between the basic reference voltages Vo0, Vo1 to Vo4 and the nodes N0, N16, N32 and N63.

Therefore, in the present invention, regardless of the brightness error between the actual and standard curve generated from the device for generating the reference voltages (for example but not limited to, the error generated from the voltage dividers VD0 to VD62 of the voltage dividing device 422), or from the structure of the liquid crystal panel or the property of liquid crystal, the reference voltage selection device 410 may reduce or minimize the error, wherein the basic reference voltages Vo0, Vo1 to Vo4 are not adjusted. In another embodiment of the present invention, the level of the basic reference voltages Vo0, Vo1 to Vo4 may also be adjusted to optimize the error of the brightness, thus the error may be further minimized. In addition, if the device for generating the reference voltages (for example but not limited to, the voltage dividing device 422) is disposed in the chip of the source driver, by the reference voltage selection device 410, the chip of the source driver may be applicable for any liquid crystal panel structure or any kind of liquid crystal. Therefore, the cost may be reduced drastically.

In one embodiment of the present invention, the reference voltage selection device 410 may be adopted for adjusting the connection between the basic reference voltages Vo0, Vo1 to Vo4 and the nodes N0, N16, N32, N48 and N63 according to a predetermined method. The predetermined method may comprise, for example, a method of looking up in a predetermined table such as a look-up table, or a method of using a calculation device (for example but not limited to, the control device 602 or a device disposed in the reference voltage selection device 410) to calculate a specific relationship between the basic reference voltages Vo0, Vo1 to Vo4 and the nodes N0, N16, N32, N48 and N63 to reduce or minimize the error between the brightness of the actual curve and the standard curve.

In one embodiment of the present invention, the voltage dividers VD0 to VD62 of the voltage dividing device 422 may comprise, for example, resistors or capacitors.

In one embodiment of the present invention, the level of the basic reference voltages Vo0, Vo1 to Vo4 may be adjusted to reduce or minimize the error between the brightness of the actual curve and the standard curve.

In one embodiment of the present invention, the reference voltage selection device 410 may be provided for generating positive or negative reference voltages V0, V1 to V63.

In another optional embodiment of the present invention, an electro-static current protect device (ESD) may be further disposed in the input terminal of each basic reference voltages Vo0, Vo1 to Vo4 of the reference voltage selection device 410 for protecting the reference voltage selection device 410 and the devices connected thereof.

In addition, the present invention also provides a display device. The display device may comprise, for example, a panel, a gate driver and a source driver. The panel may comprise a plurality of pixels, wherein each pixel may comprise a transistor. The gate driver may comprise a plurality of scan lines, wherein each scan line may be connected to the gates of the transistors of the pixels (e.g., the pixels in a row) of the liquid crystal panel. The source driver may comprise a plurality of data lines, wherein each data line may be connected to the sources of the transistors of the pixels (e.g., the pixels in a column) of the liquid crystal panel. It is noted that the source driver of the present embodiment may comprise the source driver disclosed in the foregoing embodiment of the present invention, and thus detailed description thereof will not be repeated.

Accordingly, in the present invention, regardless of the brightness error between the actual and standard curve generated from the device for generating the reference voltages, from the structure of the liquid crystal panel or the property of liquid crystal, the reference voltage selection device may be provided for reducing or minimizing the error, wherein the basic reference voltages are not adjusted. In addition, the level of the basic reference voltages may also be further adjusted to minimize the error more. In addition, if the device for generating the reference voltages is disposed in the chip of the source driver, the chip of the source driver may be applicable for any liquid crystal panel structure or any kind of liquid crystal since the reference voltage selection device of the present invention is disposed in the chip. Therefore, the cost can be effectively reduced.

The foregoing description of the embodiment of the present invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. It should be appreciated that variations may be made in the embodiments described by persons skilled in the art without departing from the scope of the present invention as defined by the following claims. Moreover, no element and component in the present disclosure is intended to be dedicated to the public regardless of whether the element or component is explicitly recited in the following claims.

What is claimed is:

1. A selection device of reference voltage, suitable for a display device comprising a digital to analog converter having a plurality of input terminals suitable for providing a predetermined displaying voltage to the display device, the selection device comprising:
a reference voltage selector, for receiving a plurality of basic reference voltages and selecting a relationship between the basic reference voltages and the input terminals to reduce an error between the displaying voltage and a predetermined standard voltage.

2. The selection device of claim 1, further comprising:
a control device, connected to the reference voltage selector, for receiving a control signal to adjust the relationship between the basic reference voltages and the input terminals.

3. The selection device of claim 2, wherein the control device comprises a register control circuit.

4. The selection device of claim 1, wherein the reference voltage selector is adopted for selecting the relationship between the basic reference voltages and the input terminals according to a predetermined method.

5. The selection device of claim 4, wherein the predetermined method comprises a method implemented on a panel with known V-T properties and several panels without known V-T properties for setting up a relationship, based on a predetermined relating algorithm.

6. The selection device of claim 4, wherein the predetermined method comprises a method implemented on multiple panels with known V-T properties by using a calculation manner to calculate a specific relationship between the basic reference voltages and the input terminals so as to minimize the error between the displaying voltage and a predetermined standard voltage.

7. The selection device of claim 1, wherein the digital to analog converter comprises:
a voltage dividing device, comprising a plurality of nodes, wherein each of the nodes is connected to one of the input terminals, and a voltage divider is connected between every two nodes.

8. The selection device of claim 7, wherein each of the voltage divider comprises a resistor or a capacitor.

9. The selection device of claim 1, wherein the reference voltage selector further comprises an electro-static current protect device disposed in a terminal for receiving one of the basic reference voltages.

10. The selection device of claim 1, wherein the basic reference voltage are adjusted to reduce the error between the displaying voltage and the predetermined standard voltage of the display device.

11. A source driver device for a display device, comprising:
a receiving device, for receiving and registering an input data and outputting a plurality of digital data in parallel;
a digital to analog converter, connected to the receiving device, for receiving and converting the digital data into a plurality of displaying voltages, wherein the digital to analog converter comprises a plurality of input terminals;
an output buffer, connected to the digital to analog converter, for outputting each of the displaying voltages to a data line; and
a reference voltage selector, for receiving a plurality of basic reference voltages, for selecting a relationship between the basic reference voltages and the input terminals to reduce an error between the displaying voltage and a predetermined standard voltage.

12. The source driver device of claim 11, wherein the receiving device comprises:
a first latch, for receiving an input data; and
a second latch, connected to the first latch, for registering the input data received by the first latch and output the digital data in parallel.

13. The source driver device of claim 12, wherein the receiving device further comprises:
a shift register, connected to the second latch, for inputting the input data received by the first latch to the second latch under a control of a timing signal.

14. The source driver device of claim 12, wherein the second latch comprises a line latch.

15. The source driver device of claim 11, further comprising:
a control device, connected to the reference voltage selector, for receiving a control signal to adjust the relationship between the basic reference voltages and the input terminals.

16. The source driver device of claim 12, wherein the control device comprises a register control circuit.

17. The source driver device of claim 12, wherein the reference voltage selector is adopted for selecting the relationship between the basic reference voltages and the input terminals according to a predetermined method.

18. The source driver device of claim 1 7, wherein the predetermined method comprises a method designed on a panel with known V-T properties and several panels without known V-T properties for setting up a relationship, based on a predetermined relating algorithm.

19. The source driver device of claim 1 7, wherein the predetermined method comprises a method designed on multiple panels with known V-T properties by using a calculation manner to calculate a specific relationship between the basic reference voltages and the input terminals so as to minimize the error between the displaying voltage and a predetermined standard voltage.

20. The source driver device of claim 11, wherein the digital to analog converter comprises:
a voltage dividing device, comprising a plurality of nodes, wherein each of the nodes is connected to one of the input terminals, and a voltage divider is connected between every two nodes.

21. The source driver device of claim 20, wherein each the voltage divider comprises a resistor or a capacitor.

22. The source driver device of claim 11, wherein in the reference voltage selector further comprises an electro-static current protect device disposed in a terminal for receiving one of the basic reference voltages.

23. The source driver device of claim 11, wherein the basic reference voltage are adjusted to reduce the error between the displaying voltage and the predetermined standard voltage of the display device.

24. A display device, comprising:
a panel, comprising a plurality of pixels, wherein each of the pixels comprises a transistor;
a gate driver, comprising a plurality of scan lines, wherein each of the scan lines is connected to a gate of one of the transistors of the pixels of the liquid crystal panel; and
a source driver, comprising a plurality of data lines, wherein each of the data lines is connected to a source of one of the transistors of the pixels of the liquid crystal panel, the source driver comprises:
a receiving device, for receiving and registering an input data, and outputting a plurality of digital data in parallel;
a digital to analog converter, connected to the receiving device, for receiving and converting the digital data into a plurality of displaying voltages, wherein the digital to analog converter comprises a plurality of input terminals;
an output buffer, connected to the digital to analog converter, for outputting each of the displaying voltages to one of the data lines; and
a reference voltage selector, for receiving a plurality of basic reference voltages, for selecting a relationship between the basic reference voltages and the input terminals to reduce an error between the displaying voltage and a predetermined standard voltage.

25. The display device of claim 24, wherein the panel comprises a liquid crystal panel.
